(19) United States
(12) Patent Application Publication
(10) Pub. No.: US 2026/0066161 A1
(43) Pub. Date: Mar. 5, 2026

(54) NEODYMIUM-IRON-BORON RARE EARTH PERMANENT MAGNET, PREPARATION METHOD THEREFOR AND USE THEREOF

(71) Applicant: FUJIAN GOLDEN DRAGON RARE-EARTH CO., LTD., Longyan, Fujian (CN)

(72) Inventors: Maolin WU, Longyan (CN); Dawei SHI, Longyan (CN); Hanjie ZHENG, Longyan (CN)

(21) Appl. No.: 19/103,558

(22) PCT Filed: Apr. 23, 2023
(86) PCT No.: PCT/CN2023/090164

§ 371 Date: Feb. 13, 2025

(30) Foreign Application Priority Data
Sep. 28, 2022 (CN) 202211195114.7

(51) Int. Cl. H01F 1/057; C22C 33/04; C22C 38/00; C22C 38/06; C22C 38/10; H01F 7/02; H01F 41/02

(52) U.S. Cl. CPC H01F 1/0577; C22C 33/04; C22C 38/002; C22C 38/005; C22C 38/06; C22C 38/10; H01F 7/021; H01F 41/0253

(57) ABSTRACT

The invention discloses a neodymium-iron-boron rare earth permanent magnet, a preparation method and use thereof. The neodymium-iron-boron rare earth permanent magnet comprises: R: 28.5-33 wt %, wherein RL comprises Pr, Pr≥14 wt %, and RH comprises one or more of Dy, Tb, Gd and Ho; Co: 12-20 wt %; Al: 0.5-1.5 wt %; X: 0.3-1.5 wt %; B: 0.88-1.05 wt %; and a balance of Fe, the microstructure thereof comprises a main phase M, a grain boundary phase A and a grain boundary phase B; the main phase M is R₂(Fe, Co)₁₄B having a volume percentage of 90-94%; the grain boundary phase A is R(Fe, Co)₂ having a volume percentage of 5-8%; and the grain boundary phase B is R₄(Fe, Co)₃ having a volume percentage of 1-2%. The neodymium-iron-boron rare earth permanent magnet has a high Co content, a high Curie temperature, a low temperature coefficient, good mechanical properties, a high magnetic energy product and a high coercive force.

### FIELD OF THE INVENTION

The invention relates to a neodymium-iron-boron rare earth permanent magnet, a preparation method and use thereof.

### BACKGROUND OF THE INVENTION

The traditional neodymium-iron-boron rare earth permanent magnets have a remanence temperature coefficient (α) of about −0.1%/° C.-0.12%/° C., and a coercive force temperature coefficient (β) of about −0.6%/° C.-0.8%/° C. Therefore, the magnetic properties thereof decay rapidly with increasing temperature. The general operating temperature does not exceed 200° C., which limits the application of neodymium-iron-boron rare earth permanent magnets in high temperature fields. In addition, the temperature coefficient of samarium cobalt permanent magnets is low, and the remanence temperature coefficient (α) thereof is about −0.035%/° C., and the coercive force temperature coefficient (β) thereof is about −0.25%/° C. However, the samarium cobalt permanent magnets have the disadvantages of higher brittleness, poorer bending strength, and lower magnetic energy product, which make it difficult to meet the increasingly high mechanical reliability and energy efficiency requirements in the field of permanent magnet motors.

The Chinese patent application CN1067134A discloses a method for preparing neodymium-iron-boron rare earth permanent magnets with a lower temperature coefficient, wherein rare earth permanent magnets with a low temperature coefficient are prepared by adding elements such as Co, Mo, Al and Dy2O3. However, the magnets prepared by this scheme have lower remanence and magnetic energy product, poorer coercivity, lower Co addition, and limited improvement in temperature coefficient.

The Chinese patent application CN1308344A discloses a heat-resistant low temperature coefficient magnet containing elements such as Co and Ga. The operating temperature of the magnet can reach 150° C., but it also has the problems of low Co addition, low Curie temperature, and limited improvement in remanence temperature coefficient. In addition, due to the presence of a Co-containing soft magnetic phase caused by the addition of Co, its remanence is low and its coercive force is poor. Even if a large amount of high coercive force elements such as Dy and Tb are added, its coercive force is less than 2000 kA/m.

The Chinese patent application CN1696324A discloses a high-temperature resistant high coercive force magnet with added Co, Cu, Al, and Nb. However, its magnetic energy product is low and the improvement of temperature coefficient is limited. In addition, the sintered magnet needs to be quickly cooled during its preparation process to avoid the precipitation of soft magnetic phase. Therefore, the preparation process thereof is complicated so that it is not suitable for large-scale production.

The Chinese patent CN101364465B discloses a Co-containing rare earth permanent magnet with nano-TiO₂, ZrO₂, MgO, and ZnO nanocrystals added. Although the coercive force of the magnet is increased by adding a large amount of Dy, Tb, Pr, etc., thereby improving its irreversible flux loss, the amount of Co added is low, so the temperature coefficient is not significantly improved.

In summary, the existing technologies currently have the product defects such as low Co addition, low Curie temperature, insignificant improvement in remanent magnetization temperature coefficient, and low coercive force or the like. In addition, in order to avoid the precipitation of soft magnetic phases during the manufacturing process after adding Co to ensure the coercive force of the magnet, a large amount of heavy rare earth needs to be added during manufacturing, and special processes such as rapid cooling are used, which are difficult to manufacture and have high manufacturing costs.

### SUMMARY OF THE INVENTION

The present invention provides a neodymium-iron-boron rare earth permanent magnet, a preparation method and use thereof in order to solve the defects of low Co addition, low Curie temperature, insignificant improvement of remanence temperature coefficient and low coercive force or the like for neodymium iron boron rare earth permanent magnets in the prior art. The neodymium-iron-boron rare earth permanent magnet of the present invention has high Co content, high Curie temperature, low temperature coefficient, good mechanical properties, high magnetic energy product and high coercive force.

In order to achieve the above object, the present invention adopts the following technical solutions.

The present invention provides a neodymium-iron-boron rare earth permanent magnet, comprising following components of:
R: 28.5-33 wt %, wherein R is a rare earth element, R comprises a light rare earth element RL and a heavy rare earth element RH, RL comprises Pr, Pr≥14 wt %, and RH comprises one or more of Dy, Tb, Gd and Ho;
Co: 12-20 wt %;
Al: 0.5-1.5 wt %;
X: 0.3-1.5 wt %, wherein X is one or more of Cu, Ga, Bi, Sn, Nb, Zr and Ti;
B: 0.88-1.05 wt %; and
a balance of Fe,
wherein wt % represents a mass percentage of a corresponding component in the neodymium-iron-boron rare earth permanent magnet, and a sum of all components is 100 wt %;
wherein the neodymium-iron-boron rare earth permanent magnet has a microstructure comprising a main phase M, a grain boundary phase A and a grain boundary phase B; the main phase M is R₂(Fe, Co)₁₄B having a volume percentage of 90-94%; the grain boundary phase A is R(Fe, Co)₂ having a volume percentage of 5-8%; and the grain boundary phase B is R₄(Fe, Co)₃ having a volume percentage of 1-2%.

The present invention selects Pr≥14 wt % and Al (0.5-1.5 wt %) while selecting high Co (12-20 wt %), which inhibits the formation of R₂Co₁₇ phase, thereby reducing the temperature coefficient while improving remanence, coercive force, magnetic energy product and mechanical properties. The main phase M is R₂(Fe, Co)₁₄B, which is the main source of magnetism, wherein Co replaces a part of the Fe atoms in the traditional R₂Fe₁₄B main phase so that the Curie temperature of the main phase is increased. Therefore, the volume percentage of the main phase M is higher, and the total volume percentage of the grain boundary phase A and the grain boundary phase B is lower, the remanence of the magnet is higher, and the temperature coefficient is relatively better (a smaller absolute value), and the coercive force is relatively low. In addition, since the fracture of neodymium-iron-boron rare earth permanent magnet is a typical intergranular fracture, the grain boundary phase plays a role in connecting the main phase grains and preventing crack propagation. The reduction in the total volume proportion of the grain boundary phase will reduce the mechanical properties. However, compared with the general neodymium-iron-boron magnets, due to the presence of the Co-rich grain boundary phase A, it has a MgCu₂-type cubic crystal structure and more slip systems than the traditional hexagonal structure Nd-rich phase. Therefore, its inherent strength during deformation is better than that of the general neodymium-rich grain boundary phase, and its mechanical properties are still better than those of the traditional low-Co and Co-free magnets.

In the present invention, the content of Pr is preferably 14 wt %-24 wt %, such as 14 wt %, 15 wt %, 16 wt %, 18 wt %, 20 wt %, 23 wt % or 24 wt %.

In the present invention, the RL may further include Nd, and the content of Nd is preferably 1 wt %-14 wt %, such as 14 wt %, 10 wt %, 12 wt %, 7.5 wt %, 9 wt %, 10 wt %, 6 wt %, 2 wt % or 1 wt %.

In the present invention, the content of RH is preferably 2 wt %-9 wt %, such as 4.5 wt %, 7 wt %, 9 wt %, 7.5 wt %, 8 wt %, 6 wt %, 2 wt % or 5 wt %.

Preferably, the RH comprises Dy, and the content of Dy is 0.2 wt %-5 wt %, such as 3 wt %, 1.5 wt %, 5 wt %, 4 wt %, 0.2 wt %, 2 wt % or 1 wt %.

Preferably, the RH comprises Tb, and the content of Tb is 1 wt %-5 wt %, such as 2.5 wt %, 3 wt %, 4 wt %, 2 wt %, 1 wt %, 1.8 wt %, 1.5 wt % or 5 wt %.

Preferably, the RH comprises Gd, and the content of Gd is 0.5 wt %-1 wt %.

Preferably, the RH comprises Ho, and the content of Ho is 0.5 wt %-2 wt %, such as 1 wt %, 0.5 wt %, 2 wt % or 1.5 wt %.

In the present invention, the content of Co is, for example, 13 wt %, 19 wt %, 12 wt %, 15 wt %, 17 wt %, 20 wt %, 16 wt % or 18 wt %.

In the present invention, the content of Al is, for example, 0.8 wt %, 0.7 wt %, 0.6 wt %, 0.5 wt %, 1.5 wt %, 0.55 wt %, 1.1 wt % or 1.3 wt %.

Preferably, X comprises Cu, and the content of Cu is 0.15 wt %-0.3 wt %, such as 0.2 wt %, 0.15 wt % or 0.3 wt %.

Preferably, X comprises Ga, and the content of Ga is 0.3 wt %-0.6 wt %, such as 0.5 wt %, 0.3 wt % or 0.6 wt %.

Preferably, X comprises Bi, and the content of Bi is 0.1 wt %-0.2 wt %.

Preferably, X comprises Sn, and the content of Sn is 0.1 wt %-0.3 wt %.

Preferably, X comprises Nb, and the content of Nb is 0.1 wt %-0.3 wt %, such as 0.2 wt %.

Preferably, X comprises Zr, and the content of Zr is 0.1 wt %-0.2 wt %.

Preferably, X comprises Ti, and the content of Ti is 0.1 wt %-0.3 wt %, such as 0.15 wt % or 0.2 wt %.

In the present invention, preferably, the main phase M comprises following components of:
26.6-30.55 wt % of R, wherein Pr: >12.5 wt %, Nd: 0-12.5 wt %, RH: 1.85-9.0 wt %;
Co: 11.8-20 wt %;
B: 0.88-1.01 wt %;
Fe: 48.5-58.5 wt %;
wherein wt % represents a mass percentage of a corresponding component in the main phase M, and a sum of all components is 100 wt %.

Preferably, the main phase M further comprises one or more of Al, Cu, Zr, Ga and O.

In the present invention, the grain boundary phase A is an RT₂ phase, which has a MgCu₂ structure and is paramagnetic at room temperature. The grain boundary phase A is a grain boundary phase that is “rich in Nd and Co and poor in Fe”.

Preferably, the grain boundary phase A comprises following components of:
R: 52.8-62 wt %; wherein Pr: 24-50 wt %, Nd: 0-26.5 wt %, RH: 2.0-10 wt %;
Co: 15-25 wt %;
Fe: 12-25 wt %;
Al: 0.19-0.55 wt %
X: 0.1-0.6 wt %;
O: 0-0.5 wt %;
wherein wt % represents a mass percentage of a corresponding component in the grain boundary phase A, and a sum of all components is 100 wt %.

In the present invention, the grain boundary phase B is a R₄T₃ phase with a Nd₄Co₃ structure. The grain boundary phase B is a grain boundary phase that is “rich in Nd and poor in Co and Fe”. The grain boundary phase B is close to the Nd-rich phase in the traditional low-Co formula system, and its components comprise mainly a rare earth metal and its oxide or a R-(T, X) alloy phase, wherein T is Fe or Co, and X is one or more of the aforementioned Cu, Ga, Bi, Sn, Nb, Zr and Ti. The grain boundary phase B mainly plays a role in demagnetizing the coupling between grains to improve the coercive force.

Preferably, the grain boundary phase B comprises following components of:
R: 75-90.3 wt %; wherein Pr: 42.5-90 wt %, Nd: 0-42.5 wt %, RH: 0.3-1.5 wt %;
Co: 6-10 wt %;
Fe: 2-10 wt %;
Al: 0-0.2 wt %
X: 1.0-10 wt %;
O: 0.5-1.5 wt %;
wherein wt % represents a mass percentage of a corresponding component in the grain boundary phase B.

Preferably, a Co content c (A) in the grain boundary phase A is higher than a Co content c (M) in the main phase M, and c(A)-c(M)>3 wt %. Ensuring that the grain boundary phase A has sufficient Co elements to form a RT₂ paramagnetic phase is beneficial to improving the coercive force of the magnet.

Preferably, a RH content in the grain boundary phase A is higher than that in the main phase M and higher than that in the grain boundary phase B. RH is concentrated in the grain boundary phase A, which improves the magnetic properties of the Co-rich grain boundaries and avoids the deterioration of the coercive force of the magnet.

Preferably, a RH content in the grain boundary phase B is lower than that in the main phase M and lower than that in the grain boundary phase A. The less RH content in the grain boundary phase B means that more RH can be obtained in the grain boundary phase A or the main phase M, which is beneficial to improve the coercive force of the magnet.

Preferably, the content of X (especially Cu and Ga) in the grain boundary phase B is higher than that in the main phase M, and higher than that in the grain boundary phase A. When the X element is distributed in the main phase, the remanence of the main phase will be reduced, while when it is distributed in the crystal phase B, it has no effect on the remanence and can form an R—X grain boundary alloy phase, thereby increasing the demagnetizing coupling between the grains and improving the coercive force of the magnet.

In the present invention, the neodymium-iron-boron rare earth permanent magnet may further comprise an impurity phase, such as a rare earth oxide phase RO or a ZrB₂/TiB₂ phase.

Among them, the content of the impurity phase can be 0.05%-0.55%, such as 0.22%, 0.25%, 0.19%, 0.20%, 0.29%, 0.19%, 0.55%, 0.23%, 0.09%, 0.21%, 0.18%, 0.37% or 0.41%.

In the present invention, the volume percentage of the main phase is, for example, 90.45%, 90.00%, 91.81%, 92.73%, 92.11%, 93.66%, 93.23%, 92.81%, 93.45%, 93.22%, 91.53% or 92.33%.

In the present invention, the volume percentage of the grain boundary phase A is, for example, 5.00%, 8.00%, 7.81%, 6.45%, 6.23%, 6.80%, 5.12%, 5.89%, 6.32%, 5.84%, 5.79%, 7.05% or 6.43%.

In the present invention, the volume percentage of the grain boundary phase B is, for example, 0.78%, 1.30%, 2.00%, 1.54%, 0.75%, 0.90%, 0.67%, 0.65%, 0.78%, 0.50%, 0.81%, 1.05% or 0.83%.

In a specific embodiment, the microstructure of the neodymium-iron-boron rare earth permanent magnet comprises 94.00% of the main phase M, 5.00% of the grain boundary phase A, 0.78% of the grain boundary phase B and 0.22% of an impurity phase.

In a specific embodiment, the microstructure of the neodymium-iron-boron rare earth permanent magnet comprises 90.45% of the main phase M, 8.00% of the grain boundary phase A, 1.30% of the grain boundary phase B and 0.25% of an impurity phase.

In a specific embodiment, the microstructure of the neodymium-iron-boron rare earth permanent magnet comprises 90.00% of the main phase M, 7.81% of the grain boundary phase A, 2.00% of the grain boundary phase B and 0.19% of an impurity phase.

In a specific embodiment, the microstructure of the neodymium-iron-boron rare earth permanent magnet comprises 91.81% of the main phase M, 6.45% of the grain boundary phase A, 1.54% of the grain boundary phase B and 0.2% of an impurity phase.

In a specific embodiment, the microstructure of the neodymium-iron-boron rare earth permanent magnet comprises 92.73% of the main phase M, 6.23% of the grain boundary phase A, 0.75% of the grain boundary phase B and 0.29% of an impurity phase.

In a specific embodiment, the microstructure of the neodymium-iron-boron rare earth permanent magnet comprises 92.11% of the main phase M, 6.80% of the grain boundary phase A, 0.90% of the grain boundary phase B and 0.19% of an impurity phase.

In a specific embodiment, the microstructure of the neodymium-iron-boron rare earth permanent magnet comprises 93.66% of the main phase M, 5.12% of the grain boundary phase A, 0.67% of the grain boundary phase B and 0.55% of an impurity phase.

In a specific embodiment, the microstructure of the neodymium-iron-boron rare earth permanent magnet comprises 93.23% of the main phase M, 5.89% of the grain boundary phase A, 0.65% of the grain boundary phase B and 0.23% of an impurity phase.

In a specific embodiment, the microstructure of the neodymium-iron-boron rare earth permanent magnet comprises 92.81% of the main phase M, 6.32% of the grain boundary phase A, 0.78% of the grain boundary phase B and 0.09% of an impurity phase.

In a specific embodiment, the microstructure of the neodymium-iron-boron rare earth permanent magnet comprises 93.45% of the main phase M, 5.84% of the grain boundary phase A, 0.50% of the grain boundary phase B and 0.21% of an impurity phase.

In a specific embodiment, the microstructure of the neodymium-iron-boron rare earth permanent magnet comprises 93.22% of the main phase M, 5.79% of the grain boundary phase A, 0.81% of the grain boundary phase B and 0.18% of an impurity phase.

In a specific embodiment, the microstructure of the neodymium-iron-boron rare earth permanent magnet comprises 91.53% of the main phase M, 7.05% of the grain boundary phase A, 1.05% of the grain boundary phase B and 0.37% of an impurity phase.

In a specific embodiment, the microstructure of the neodymium-iron-boron rare earth permanent magnet comprises 92.33% of the main phase M, 6.43% of the grain boundary phase A, 0.83% of the grain boundary phase B and 0.41% of an impurity phase.

In the present invention, preferably, the neodymium-iron-boron rare earth permanent magnet has a remanence temperature coefficient |α| at 20-100° C. of less than 0.056%/° C., and a coercive force temperature coefficient |β| at 20-100° C. of less than 0.55%/° C.

In the present invention, preferably, the neodymium-iron-boron rare earth permanent magnet has a Curie temperature Tc of greater than 450° C.

In the present invention, preferably, the neodymium-iron-boron rare earth permanent magnet has a coercive force Hcj, Hcj≥25 kOe.

The present invention further provides a method for preparing a neodymium-iron-boron rare earth permanent magnet, comprising subjecting a raw material composition for the neodymium-iron-boron rare earth permanent magnet to the following steps in sequence: smelting, casting, hydrogen decrepitation, shaping, sintering and aging treatments.

In the present invention, the smelting can be obtained by conventional methods in the art, for example, smelting in a high-frequency vacuum induction melting furnace.

Wherein, the vacuum degree of the high-frequency vacuum induction melting furnace can be 5×10⁻² Pa.

The smelting temperature may be 1600° C. or less.

The smelting is generally carried out in a crucible made of alumina. The crucible made of alumina will introduce a portion of Al into the neodymium-iron-boron rare earth permanent magnet.

In the present invention, the casting process can be a conventional casting process in the art, for example, in an Ar atmosphere, the molten liquid obtained by smelting is passed through a rotating roller and cooled.

Wherein, the pressure of the Ar atmosphere is preferably 5.5×10⁴ Pa.

Wherein, the cooling rate is preferably 102° C./sec−104° C./sec. The cooling can be achieved by passing cooling water through the roller. Preferably, the inlet temperature of the cooling water is ≤25° C.

In the present invention, the hydrogen decrepitation process can be a conventional hydrogen decrepitation process in the art, comprising such as hydrogen absorption, dehydrogenation, and cooling treatments.

The hydrogen absorption can be carried out under the condition of hydrogen pressure of 0.05-0.25 MPa. The dehydrogenation can be carried out under a condition of increasing the temperature while vacuum pumping.

In the present invention, the method further comprises pulverization after the hydrogen decrepitation by conventional means in the art. The pulverization process can be a conventional pulverization process in the art, such as jet mill pulverization.

The jet mill pulverization can be carried out in a nitrogen atmosphere with an oxidizing gas content of less than 100 ppm. The oxidizing gas refers to oxygen and/or moisture.

The pressure of the grinding chamber of the jet mill can be 0.58 MPa.

The time of the jet mill pulverization can be 3 hours.

The particle size of the powder after the pulverization is preferably 3.5-4.5 μm.

After the pulverization, a lubricant, such as zinc stearate, can be added to the powder by conventional means in the art. The amount of the lubricant added can be 0.10-0.15% of the weight of the mixed powder, such as 0.12%.

In the present invention, the shaping process can be a conventional shaping process in the art, such as a magnetic field orientation shaping method. When the magnetic field orientation shaping method is used, the pressure of the orientation pressing shaping is greater than 80 MPa, the orientation magnetic field is greater than 1.2T, and the holding time is 4-6 s.

After the magnetic field orientation shaping, cold isostatic pressing can be continued to further densify the magnet, and the pressure of the cold isostatic pressing is 150-160 MPa.

In the present invention, the sintering process may be a conventional sintering process in the art, for example, preheating, sintering, and cooling under vacuum conditions.

Wherein, the vacuum condition is, for example, 5×10⁻³ Pa.

The preheating temperature may be 300-600° C. The preheating time may be 1-2 h. Preferably, the preheating comprises preheating at 300° C. and 600° C. for 1 h respectively.

The sintering temperature may be a conventional sintering temperature in the art, such as 1040-1090° C.

The sintering time may be a conventional sintering time in the art, such as 4 h.

Ar gas may be introduced before cooling to make the gas pressure reach 0.05-0.1 MPa.

Preferably, the rapid cooling process is not used in the sintering. The rapid cooling process refers to a cooling process with a cooling rate of 80° C./min or more.

In the present invention, the aging treatment includes a primary aging treatment and a secondary aging treatment.

Wherein, the temperature of the primary aging treatment is preferably 860-960° C., for example, 900° C. In the primary aging treatment, the heating rate to 860-960° C. is preferably 3-5° C./min. The starting point of the heating may be room temperature. The time of the primary aging treatment may be 3 h.

The temperature of the secondary aging treatment is preferably 430-600° C. In the secondary aging treatment, the heating rate to 430-600° C. is preferably 3-5° C./min. The starting point of the heating may be room temperature. The time of the secondary aging treatment may be 3 h.

In the present invention, the room temperature refers to 25° C.±5° C.

The present invention further provides use of the neodymium-iron-boron rare earth permanent magnet in electronic components.

Among them, the electronic components can be conventional in the field, such as electronic components in motors.

On the basis of conforming to the common sense in the art, the above-mentioned preferred conditions can be arbitrarily combined to obtain the preferred embodiments of the present invention.

The reagents and raw materials used in the present invention are commercially available.

The positive effects of the present invention are as follows:

In the neodymium-iron-boron rare earth permanent magnet of the present invention, under the condition of adding high content of Co, a low melting point grain boundary phase of uniformly distributed RT₂ type and R₄T₃ type structure is formed by the mutual cooperation of elements such as Pr and Al. This avoids the defect in traditional high-Co magnets that soft magnetic phases such as R₂Co₁₇ are easily present, which leads to a significant reduction in coercive force. The magnet of the present invention has higher remanence (11.5-13.5 kGs), coercive force (up to 28 kOe or more) and squareness (>95%), lower remanence temperature coefficient (|α|<0.056%/° C., 20-100° C.) and coercive force temperature coefficient (|β|<0.55%/° C., 20-100° C.), higher Curie temperature (Tc>450° C.), and excellent heat resistance.

### BRIEF DESCRIPTION OF THE DRAWINGS

FIG. 1 shows the scanning electron microscope-backscattered electron (SEM-BSE) image of different phases in the neodymium-iron-boron rare earth permanent magnet of Example 1.

### DETAILED DESCRIPTION OF THE INVENTION

The present invention is further illustrated by way of examples below, but the present invention is not limited to the scope of the examples described. The experimental methods in the following examples that do not specify specific conditions shall be selected according to conventional methods and conditions or according to the product specifications.

### Examples 1-13 and Comparative Examples 1-7

The raw material compositions of the neodymium-iron-boron rare earth permanent magnets in Example 1-13 and Comparative Example 1-7 are shown in Table 1.

According to the raw material compositions of the neodymium-iron-boron rare earth permanent magnets in Table 1, the materials are proportioned and the following steps were performed in sequence:
(1) Smelting Process: According to the raw material compositions shown in Table 1, the prepared raw materials were placed in a crucible made of alumina and vacuum smelted in a high-frequency vacuum induction melting furnace at a vacuum of 5×10⁻² Pa at a temperature of 1600° C. or less.
(2) Casting Process: In an Ar atmosphere with a pressure of 5.5×10⁴ Pa, the molten liquid after vacuum smelting was cast through a rotating roller. Then, cooling water (water inlet temperature ≤25° C.) was passed into the roller, and the roller was cooled at a cooling rate of 102° C./s−104° C./s.
(3) Hydrogen Decrepitation Process: At room temperature, hydrogen with a purity of 99.9% was introduced into the hydrogen pulverization furnace, and the hydrogen pressure was maintained at 0.15 MPa. After sufficient hydrogen absorption, the temperature was raised while vacuuming. After sufficient dehydrogenation, the powder was cooled and taken out after pulverization by hydrogen decrepitation.
(4) Jet Mill Pulverization: In a nitrogen atmosphere with an oxidizing gas content of 100 ppm or less, the powder after pulverization by hydrogen decrepitation was subjected to jet milling for 3 hours under the condition of a pulverizing chamber pressure of 0.58 MPa to obtain a fine powder. The oxidizing gas refers to oxygen and/or water.
(5) Zinc stearate was added to the powder after the jet mill pulverization. The amount of zinc stearate added was 0.12% of the weight of the mixed powder. Then a V-type mixer was used to mix the powder thoroughly.
(6) Magnetic Field Shaping Process: Using a right-angle oriented magnetic field molding machine, the powder with zinc stearate added was pressed for 4-6 seconds in an oriented magnetic field of 1.6T at a shaping pressure greater than 80 MPa. Then, an isostatic pressing machine was used to perform cold isostatic pressing at a pressure of 150-160 MPa to further densify the magnet.
(7) Sintering Process: Each shaped body was moved to a sintering furnace for sintering. Sintering was carried out under a vacuum of 5×10⁻³ Pa by, after preheating at 300° C. and 600° C. for 1 hour each, and then sintering at 1040° C. for 4 hours. After that, Ar gas was introduced to make the gas pressure reach 0.1 MPa. Then the shaped body was cooled to room temperature at a cooling rate less than 80° C./min.
(9) Aging Process: The sintered body was heated from room temperature to 900° C. in high-purity Ar gas at a heating rate of 5° C./min, heat treated for 3 hours (the primary aging), and then cooled to room temperature. The sintered body was then heated from room temperature to 600° C. at a heating rate of 5° C./min and heat treated for 3 h (the secondary aging) to obtain a neodymium-iron-boron rare earth permanent magnet.

TABLE 1
Formulas of the raw material compositions of the neodymium-
iron-boron rare earth permanent magnet (wt %)

| | R | | | | | | X | | | | | | | | | | |
|---|---|---|---|---|---|---|---|---|---|---|---|---|---|---|---|---|---|
| | Nd | Pr | Dy | Tb | Gd | Ho | Cu | Ga | Bi | Sn | Nb | Zr | Ti | Al | Co | B | Fe |
| Example 1 | 10 | 14 | 3 | 0 | 0.5 | 1 | 0.2 | 0.5 | 0 | 0 | 0 | 0.2 | 0 | 0.8 | 13 | 0.92 | 55.88 |
| Example 2 | 14 | 14 | 1.5 | 2.5 | 0 | 0.5 | 0.15 | 0 | 0 | 0 | 0 | 0 | 0.15 | 0.7 | 19 | 0.95 | 46.55 |
| Example 3 | 12 | 14 | 3 | 3 | 0 | 1 | 0.2 | 0 | 0.2 | 0 | 0 | 0 | 0.2 | 0.6 | 12 | 1.05 | 52.75 |
| Example 4 | 7.5 | 15 | 5 | 4 | 0 | 0 | 0 | 0.3 | 0 | 0 | 0.2 | 0 | 0 | 0.5 | 15 | 0.99 | 51.51 |
| Example 5 | 7.5 | 15 | 5 | 2.5 | 0 | 0 | 0.2 | 0.3 | 0 | 0 | 0 | 0.2 | 0 | 0.5 | 17 | 0.91 | 50.89 |
| Example 6 | 7.5 | 15 | 4 | 2 | 0 | 2 | 0.15 | 0 | 0.1 | 0.3 | 0 | 0.2 | 0 | 1.5 | 20 | 0.97 | 46.28 |
| Example 7 | 9 | 16 | 4 | 1 | 1 | 0 | 0.3 | 0.6 | 0 | 0 | 0.2 | 0.1 | 0.3 | 0.5 | 13 | 0.88 | 53.12 |
| Example 8 | 10 | 18 | 0.2 | 1.8 | 0 | 0 | 0.2 | 0.3 | 0 | 0 | 0 | 0.2 | 0 | 0.55 | 15 | 0.95 | 52.8 |
| Example 9 | 6 | 18 | 4 | 1.5 | 1 | 1 | 0.2 | 0.3 | 0 | 0 | 0 | 0.2 | 0 | 0.55 | 15 | 0.95 | 51.3 |
| Example 10 | 6 | 18 | 0 | 3 | 0.5 | 1.5 | 0.15 | 0 | 0.1 | 0 | 0 | 0.2 | 0 | 0.6 | 16 | 0.96 | 52.99 |
| Example 11 | 2 | 20 | 2 | 5 | 0 | 0 | 0.15 | 0 | 0 | 0.3 | 0 | 0.2 | 0 | 0.6 | 16 | 0.96 | 52.79 |
| Example 12 | 1 | 23 | 5 | 2.5 | 0 | 0 | 0.2 | 0.5 | 0 | 0 | 0 | 0 | 0.2 | 1.1 | 18 | 0.98 | 47.52 |
| Example 13 | 0 | 24 | 1 | 5 | 1 | 0 | 0.2 | 0.5 | 0 | 0 | 0 | 0 | 0.2 | 1.3 | 18 | 0.95 | 47.85 |
| Comparative | 20 | 2 | 2 | 5 | 0 | 0 | 0.15 | 0 | 0 | 0.3 | 0 | 0.2 | 0 | 0.6 | 16 | 0.96 | 52.79 |
| Example 1 | | | | | | | | | | | | | | | | | |
| Comparative | 14 | 12 | 3 | 3 | 0 | 1 | 0.2 | 0 | 0.2 | 0 | 0 | 0 | 0.2 | 0.6 | 5 | 1.05 | 59.75 |
| Example 2 | | | | | | | | | | | | | | | | | |
| Comparative | 16 | 10 | 3 | 3 | 1 | 0 | 0.2 | 0 | 0.2 | 0 | 0 | 0 | 0.2 | 0.6 | 25 | 1.05 | 39.75 |
| Example 3 | | | | | | | | | | | | | | | | | |
| Comparative | 7.5 | 15 | 5 | 4 | 0 | 0 | 0 | 0.3 | 0 | 0 | 0.2 | 0 | 0 | 0 | 15 | 0.99 | 52.01 |
| Example 4 | | | | | | | | | | | | | | | | | |
| Comparative | 7.5 | 15 | 5 | 4 | 0 | 0 | 0 | 0.3 | 0 | 0 | 0.2 | 0 | 0 | 2 | 15 | 0.99 | 50.01 |
| Example 5 | | | | | | | | | | | | | | | | | |
| Comparative | 8 | 18 | 0.2 | 1.3 | 0 | 0 | 0.15 | 0 | 0 | 0 | 0 | 0.1 | 0 | 0.55 | 15 | 0.95 | 55.75 |
| Example 6 | | | | | | | | | | | | | | | | | |
| Comparative | 6 | 18 | 4 | 5 | 1 | 1 | 0.5 | 0.6 | 0 | 0 | 0.2 | 0.2 | 0.3 | 0.55 | 15 | 0.95 | 46.7 |
| Example 7 | | | | | | | | | | | | | | | | | |

Effect Example 1: Phase compositions and component detection of the neodymium-iron-boron rare earth permanent magnets

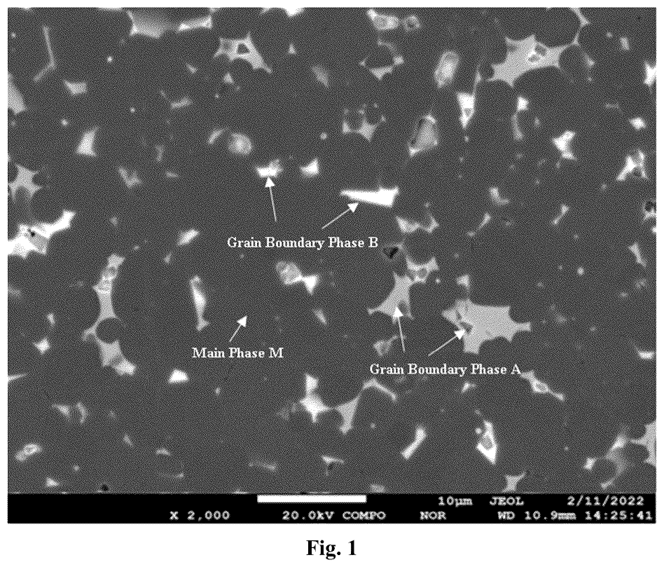

The scanning electron microscope-backscattered electron (SEM-BSE) image of different phases in the neodymium-iron-boron rare earth permanent magnet of Example 1 is shown in FIG. 1, which shows the main phase M, the crystal phase A and the crystal phase B.

The volume percentages of respective phases in the neodymium-iron-boron rare earth permanent magnets in Examples 1-13 and Comparative Examples 1-7 are shown in Table 2, and the compositions of respective phases are shown in Table 3.

TABLE 2
Compositions of the phases of the neodymium-
iron-boron rare earth permanent magnets

| | | Grain | Grain | |
|---|---|---|---|---|
| | Main | Boundary | Boundary | |
| | Phase | Phase | Phase | Impurity |
| | M (%) | A (%) | B (%) | Phase (%) |
| Example 1 | 94.00 | 5.00 | 0.78 | 0.22 |
| Example 2 | 90.45 | 8.00 | 1.30 | 0.25 |
| Example 3 | 90.00 | 7.81 | 2.00 | 0.19 |
| Example 4 | 91.81 | 6.45 | 1.54 | 0.20 |
| Example 5 | 92.73 | 6.23 | 0.75 | 0.29 |
| Example 6 | 92.11 | 6.80 | 0.90 | 0.19 |
| Example 7 | 93.66 | 5.12 | 0.67 | 0.55 |
| Example 8 | 93.23 | 5.89 | 0.65 | 0.23 |
| Example 9 | 92.81 | 6.32 | 0.78 | 0.09 |
| Example 10 | 93.45 | 5.84 | 0.50 | 0.21 |
| Example 11 | 93.22 | 5.79 | 0.81 | 0.18 |
| Example 12 | 91.53 | 7.05 | 1.05 | 0.37 |
| Example 13 | 92.33 | 6.43 | 0.83 | 0.41 |
| Comparative Example 1 | 93.32 | 5.66 | 0.71 | 0.31 |
| Comparative Example 2 | 91.00 | 4.58 | 4.13 | 0.29 |
| Comparative Example 3 | 90.30 | 4.83 | 2.61 | 2.26 |
| Comparative Example 4 | 91.78 | 6.57 | 1.28 | 0.37 |
| Comparative Example 5 | 91.63 | 6.36 | 1.62 | 0.39 |
| Comparative Example 6 | 96.14 | 2.13 | 0.62 | 1.11 |
| Comparative Example 7 | 86.34 | 9.13 | 3.25 | 1.28 |

The percentages in Table 2 are volume percentages, estimated based on the stereological Delesse Law, that is, VV (component volume percentage)=AA (cross-sectional component area percentage), wherein the area percentage of a component on a random cross section is equal to its volume percentage.

TABLE 3
Ingredient compositions of respective phases of the neodymium-iron-boron rare earth permanent magnets

| | R | | | | | | M | | | | | | | | | | | |
|---|---|---|---|---|---|---|---|---|---|---|---|---|---|---|---|---|---|---|
| | Nd | Pr | Dy | Tb | Gd | Ho | Cu | Ga | Bi | Sn | Nb | Zr | Ti | O | Al | Co | B | Fe |
| Main Phase | | | | | | | | | | | | | | | | | | |
| Example 1 | 9.11 | 13.01 | 3.08 | 0.85 | 0.47 | 0.94 | 0.13 | 0.35 | 0 | 0 | 0 | 0.015 | 0 | 0 | 0.85 | 12.78 | 0.88 | 58.38 |
| Example 2 | 12.45 | 12.5 | 1.54 | 0.74 | 0 | 0.45 | 0.12 | 0 | 0 | 0 | 0 | 0 | 0.01 | 0 | 0.74 | 18.76 | 0.92 | 49.997 |
| Example 3 | 10.77 | 12.78 | 2.93 | 0.64 | 0 | 0.98 | 0.11 | 0 | 0.04 | 0 | 0 | 0 | 0.02 | 0 | 0.64 | 11.88 | 1.01 | 55.773 |
| Example 4 | 6.82 | 13.56 | 5.09 | 0.51 | 0 | 0 | 0 | 0.11 | 0 | 0 | 0.02 | 0 | 0 | 0 | 0.51 | 14.85 | 0.95 | 54.177 |
| Example 5 | 6.94 | 13.63 | 4.95 | 0.52 | 0 | 0 | 0.14 | 0.15 | 0 | 0 | 0 | 0.01 | 0 | 0 | 0.52 | 16.93 | 0.89 | 53.314 |
| Example 6 | 6.92 | 13.64 | 3.94 | 1.57 | 0 | 1.94 | 0.11 | 0 | 0.03 | 0.13 | 0 | 0.01 | 0 | 0 | 1.57 | 20.00 | 0.95 | 48.807 |
| Example 7 | 8.54 | 15.01 | 3.93 | 0.56 | 0.93 | 0 | 0.15 | 0.45 | 0 | 0 | 0.02 | 0.02 | 0.01 | 0 | 0.56 | 12.94 | 0.90 | 55.557 |
| Example 8 | 9.15 | 16.35 | 0.15 | 0.64 | 0 | 0 | 0.12 | 0.18 | 0 | 0 | 0 | 0.01 | 0 | 0 | 0.64 | 14.89 | 0.93 | 55.851 |
| Example 9 | 5.54 | 16.42 | 3.96 | 0.58 | 0.92 | 0.95 | 0.13 | 0.19 | 0 | 0 | 0 | 0.01 | 0 | 0 | 0.58 | 14.86 | 0.93 | 53.946 |
| Example 10 | 5.55 | 16.55 | 0.00 | 0.67 | 0.46 | 1.45 | 0.12 | 0 | 0.04 | 0 | 0 | 0.02 | 0 | 0 | 0.67 | 15.92 | 0.94 | 55.304 |
| Example 11 | 1.90 | 18.43 | 1.95 | 0.62 | 0 | 0 | 0.12 | 0 | 0 | 0.15 | 0 | 0.02 | 0 | 0 | 0.62 | 15.93 | 0.92 | 54.898 |
| Example 12 | 0.94 | 20.56 | 4.96 | 1.15 | 0 | 0 | 0.1 | 0.32 | 0 | 0 | 0 | 0 | 0.01 | 0 | 1.15 | 17.88 | 0.94 | 50.671 |
| Example 13 | 0.00 | 22.03 | 0.95 | 1.39 | 0.93 | 0 | 0.11 | 0.33 | 0 | 0 | 0 | 0 | 0.01 | 0 | 1.39 | 17.86 | 0.93 | 50.47 |
| Comparative | 18.53 | 1.95 | 2.05 | 0.69 | 0 | 0 | 0.12 | 0 | 0 | 0.15 | 0 | 0.01 | 0 | 0 | 0.69 | 15.87 | 0.92 | 54.755 |
| Example 1 | | | | | | | | | | | | | | | | | | |
| Comparative | 12.25 | 10.26 | 2.98 | 0.60 | 0 | 0.91 | 0.11 | 0 | 0.03 | 0 | 0 | 0 | 0.01 | 0 | 0.60 | 4.75 | 1.01 | 64.057 |
| Example 2 | | | | | | | | | | | | | | | | | | |
| Comparative | 14.85 | 8.87 | 3.07 | 0.62 | 0.94 | 0 | 0.12 | 0 | 0.04 | 0 | 0 | 0 | 0.02 | 0 | 0.62 | 25.34 | 1.01 | 42.068 |
| Example 3 | | | | | | | | | | | | | | | | | | |
| Comparative | 6.68 | 13.21 | 4.96 | 0.00 | 0 | 0 | 0.05 | 0.18 | 0 | 0 | 0.01 | 0 | 0 | 0 | 0.00 | 14.95 | 0.95 | 55.06 |
| Example 4 | | | | | | | | | | | | | | | | | | |
| Comparative | 6.71 | 13.33 | 5.03 | 2.06 | 0 | 0 | 0.06 | 0.17 | 0 | 0 | 0.02 | 0 | 0 | 0 | 2.06 | 14.88 | 0.95 | 52.773 |
| Example 5 | | | | | | | | | | | | | | | | | | |
| Comparative | 7.84 | 17.58 | 0.18 | 0.59 | 0 | 0 | 0.1 | 0 | 0 | 0 | 0 | 0.02 | 0 | 0 | 0.59 | 15.12 | 0.91 | 56.307 |
| Example 6 | | | | | | | | | | | | | | | | | | |
| Comparative | 4.88 | 14.52 | 3.92 | 0.58 | 0.89 | 0.96 | 0.27 | 0.35 | 0 | 0 | 0.02 | 0.01 | 0.04 | 0 | 0.58 | 15.03 | 0.91 | 52.699 |
| Example 7 | | | | | | | | | | | | | | | | | | |
| Grain | | | | | | | | | | | | | | | | | | |
| Boundary | | | | | | | | | | | | | | | | | | |
| Phase A | | | | | | | | | | | | | | | | | | |
| Example 1 | 21.79 | 28.2 | 3.12 | 0 | 0.55 | 1.10 | 0.14 | 0.25 | 0 | 0 | 0 | 0 | 0 | 0.44 | 0.31 | 18.97 | 5.62 | 19.95 |
| Example 2 | 26.40 | 26.6 | 1.67 | 2.87 | 0 | 0.62 | 0.19 | 0 | 0 | 0 | 0 | 0 | 0 | 0.3 | 0.33 | 24.08 | 5.03 | 12.21 |
| Example 3 | 23.35 | 24.11 | 3.30 | 3.39 | 0 | 1.16 | 0.16 | 0 | 0.11 | 0 | 0 | 0 | 0 | 0.45 | 0.22 | 15.42 | 4.02 | 24.76 |
| Example 4 | 14.61 | 28.33 | 5.50 | 4.43 | 0 | 0 | 0.09 | 0.23 | 0 | 0 | 0 | 0 | 0 | 0.24 | 0.25 | 19.27 | 4.02 | 23.28 |
| Example 5 | 15.56 | 31.12 | 5.55 | 2.79 | 0 | 0 | 0.06 | 0.24 | 0 | 0 | 0 | 0 | 0 | 0.38 | 0.23 | 20.83 | 4.01 | 19.6 |
| Example 6 | 15.43 | 30.51 | 4.49 | 2.28 | 0 | 2.28 | 0.21 | 0 | 0.07 | 0.09 | 0 | 0 | 0 | 0.21 | 0.54 | 23.09 | 3.09 | 17.92 |
| Example 7 | 19.04 | 31.25 | 4.48 | 1.18 | 1.14 | 0 | 0.09 | 0.39 | 0 | 0 | 0 | 0 | 0 | 0.4 | 0.24 | 17.38 | 4.03 | 20.78 |
| Example 8 | 21.64 | 37.95 | 0.31 | 2.08 | 0 | 0 | 0.06 | 0.15 | 0 | 0 | 0 | 0 | 0 | 0.43 | 0.28 | 19.27 | 4.02 | 14.25 |
| Example 9 | 12.95 | 36.85 | 4.45 | 1.72 | 1.18 | 1.14 | 0.08 | 0.19 | 0 | 0 | 0 | 0 | 0 | 0.34 | 0.19 | 19.58 | 5.03 | 16.64 |
| Example 10 | 12.97 | 36.63 | 0.00 | 3.38 | 0.61 | 1.71 | 0.13 | 0 | 0.07 | 0 | 0 | 0 | 0 | 0.26 | 0.20 | 19.23 | 3.03 | 22.04 |
| Example 11 | 4.29 | 40.36 | 2.22 | 5.58 | 0 | 0 | 0.15 | 0 | 0 | 0.09 | 0 | 0 | 0 | 0.27 | 0.29 | 19.26 | 3.06 | 24.7 |
| Example 12 | 2.15 | 47.53 | 5.54 | 2.78 | 0 | 0 | 0.19 | 0.35 | 0 | 0 | 0 | 0 | 0 | 0.43 | 0.48 | 21.11 | 3.01 | 16.9 |
| Example 13 | 0.00 | 48.23 | 1.16 | 5.58 | 1.19 | 0 | 0.11 | 0.32 | 0 | 0 | 0 | 0 | 0 | 0.24 | 0.45 | 22.15 | 4.05 | 16.78 |
| Comparative | 38.30 | 3.45 | 2.23 | 5.60 | 0 | 0 | 0.21 | 0 | 0 | 0.09 | 0 | 0 | 0 | 0.44 | 0.30 | 21.27 | 5.07 | 23.48 |
| Example 1 | | | | | | | | | | | | | | | | | | |
| Comparative | 24.67 | 23.42 | 3.32 | 3.40 | 0 | 1.14 | 0.11 | 0 | 0.10 | 0 | 0 | 0 | 0 | 0.47 | 0.27 | 10.77 | 4.02 | 28.78 |
| Example 2 | | | | | | | | | | | | | | | | | | |
| Comparative | 26.32 | 20.42 | 3.37 | 3.31 | 1.12 | 0 | 0.12 | 0 | 0.07 | 0 | 0 | 0 | 0 | 0.38 | 0.26 | 35.21 | 4.01 | 5.781 |
| Example 3 | | | | | | | | | | | | | | | | | | |
| Comparative | 16.64 | 33.29 | 5.59 | 4.47 | 0 | 0 | 0.02 | 0.24 | 0 | 0 | 0 | 0 | 0 | 0.4 | 0.02 | 18.32 | 3.07 | 18.35 |
| Example 4 | | | | | | | | | | | | | | | | | | |
| Comparative | 15.36 | 31.25 | 5.52 | 4.47 | 0 | 0 | 0.06 | 0.22 | 0 | 0 | 0 | 0 | 0 | 0.37 | 0.75 | 19.33 | 4.08 | 18.96 |
| Example 5 | | | | | | | | | | | | | | | | | | |
| Comparative | 15.44 | 31.36 | 0.31 | 1.45 | 0 | 0 | 0.07 | 0 | 0 | 0 | 0 | 0 | 0 | 0.37 | 0.19 | 18.28 | 3.03 | 29.86 |
| Example 6 | | | | | | | | | | | | | | | | | | |
| Comparative | 12.21 | 35.49 | 4.48 | 5.52 | 1.15 | 1.14 | 0.27 | 0.34 | 0 | 0 | 0 | 0 | 0 | 0.31 | 0.23 | 18.26 | 3.01 | 17.89 |
| Example 7 | | | | | | | | | | | | | | | | | | |
| Grain | | | | | | | | | | | | | | | | | | |
| Boundary | | | | | | | | | | | | | | | | | | |
| Phase B | | | | | | | | | | | | | | | | | | |
| Example 1 | 32.86 | 42.61 | 0.33 | 0 | 0.13 | 0.12 | 2.33 | 5.53 | 0 | 0 | 0 | 0 | 0 | 1.06 | 0.10 | 6.98 | 0 | 9.01 |
| Example 2 | 42.33 | 42.83 | 0.20 | 0.28 | 0 | 0.12 | 1.00 | 0 | 0 | 0 | 0 | 0 | 0 | 1.23 | 0.09 | 9.88 | 0 | 3.32 |
| Example 3 | 37.45 | 45.80 | 0.39 | 0.35 | 0 | 0.14 | 1.33 | 0 | 2.14 | 0 | 0 | 0 | 0 | 0.68 | 0.09 | 6.26 | 0 | 6.04 |
| Example 4 | 27.11 | 52.12 | 0.52 | 0.49 | 0 | 0 | 0 | 3.29 | 0 | 0 | 2.10 | 0 | 0 | 0.52 | 0.10 | 8.01 | 0 | 6.28 |
| Example 5 | 26.65 | 52.11 | 0.56 | 0.25 | 0 | 0 | 1.37 | 3.19 | 0 | 0 | 0 | 0 | 0 | 1.15 | 0.03 | 8.99 | 0 | 6.84 |
| Example 6 | 24.41 | 50.30 | 0.46 | 0.29 | 0 | 0.30 | 0.91 | 0 | 1.01 | 3.27 | 0 | 0 | 0 | 1.31 | 0.01 | 10.0 | 0 | 9.04 |
| Example 7 | 21.33 | 56.60 | 0.40 | 0.15 | 0.11 | 0 | 2.08 | 5.91 | 0 | 0 | 2.01 | 0 | 0 | 0.76 | 0.05 | 6.96 | 0 | 4.39 |
| Example 8 | 22.36 | 61.32 | 0.05 | 0.28 | 0 | 0 | 1.27 | 3.02 | 0 | 0 | 0 | 0 | 0 | 0.61 | 0.10 | 7.67 | 0 | 3.93 |
| Example 9 | 16.68 | 61.62 | 0.43 | 0.19 | 0.18 | 0.11 | 1.49 | 3.23 | 0 | 0 | 0 | 0 | 0 | 0.93 | 0.05 | 7.60 | 0 | 8.41 |
| Example 10 | 18.23 | 62.82 | 0 | 0.38 | 0.13 | 0.20 | 1.05 | 0 | 1.14 | 0 | 0 | 0 | 0 | 1.23 | 0.07 | 8.05 | 0 | 7.92 |
| Example 11 | 7.05 | 73.61 | 0.30 | 0.54 | 0 | 0 | 1.18 | 0 | 0 | 3.03 | 0 | 0 | 0 | 0.74 | 0.10 | 8.19 | 0 | 5.99 |
| Example 12 | 3.32 | 77.36 | 0.58 | 0.28 | 0 | 0 | 1.42 | 5.23 | 0 | 0 | 0 | 0 | 0 | 1.30 | 0.10 | 9.21 | 0 | 2.50 |
| Example 13 | 0 | 82.41 | 0.14 | 0.54 | 0.20 | 0 | 0 | 5.23 | 0 | 0 | 0 | 0 | 0 | 1.06 | 0.05 | 9.28 | 0 | 2.16 |
| Comparative | 76.32 | 7.42 | 0.22 | 0.59 | 0 | 0 | 1.00 | 0 | 0 | 3.26 | 0 | 0 | 0 | 1.11 | 0.03 | 8.17 | 0 | 2.99 |
| Example 1 | | | | | | | | | | | | | | | | | | |
| Comparative | 45.23 | 39.45 | 0.32 | 0.40 | 0 | 0.13 | 1.45 | 0 | 2.16 | 0 | 0 | 0 | 0 | 0.55 | 0.05 | 2.64 | 0 | 8.16 |
| Example 2 | | | | | | | | | | | | | | | | | | |
| Comparative | 43.64 | 36.60 | 0.33 | 0.32 | 0.13 | 0 | 1.21 | 0 | 2.18 | 0 | 0 | 0 | 0 | 0.84 | 0.07 | 12.94 | 0 | 2.57 |
| Example 3 | | | | | | | | | | | | | | | | | | |
| Comparative | 23.71 | 56.11 | 0.52 | 0.45 | 0 | 0 | 0.07 | 3.02 | 0 | 0 | 2.04 | 0 | 0 | 1.45 | 0.06 | 7.89 | 0 | 6.14 |
| Example 4 | | | | | | | | | | | | | | | | | | |
| Comparative | 23.72 | 56.12 | 0.59 | 0.44 | 0 | 0 | 0.05 | 3.28 | 0 | 0 | 2.18 | 0 | 0 | 1.20 | 0.03 | 7.79 | 0 | 5.82 |
| Example 5 | | | | | | | | | | | | | | | | | | |
| Comparative | 18.49 | 67.35 | 0.06 | 0.23 | 0 | 0 | 1.19 | 0 | 0 | 0 | 0.23 | 0 | 0 | 1.12 | 0.03 | 7.82 | 0 | 4.60 |
| Example 6 | | | | | | | | | | | | | | | | | | |
| Comparative | 12.68 | 61.40 | 0.47 | 0.59 | 0.19 | 0.13 | 3.11 | 6.19 | 0 | 0 | 0 | 0 | 0 | 0.67 | 0.09 | 7.68 | 0 | 7.46 |
| Example 7 | | | | | | | | | | | | | | | | | | |

### Effect Example 2: Performance Test of the Magnets

The magnetic properties of the neodymium-iron-boron rare earth permanent magnets were tested by using the PFM-14 pulse magnetic properties measuring instrument from the China National Institute of Metrology. Table 4 shows the test results of the magnetic properties.

TABLE 4
Magnetic properties of the neodymium-iron-boron rare earth permanent magnets

| | | | | | | | | | | Bending |
|---|---|---|---|---|---|---|---|---|---|---|
| | | | | | | | | | | Strength |
| | | | | | | | | Br | Hcj | (Mpa) |
| | | | | | | | | Temperature | Temperature | in parallel |
| | Br | Hcb | Hcj | Hk | BHmax | Squareness | Tc | Coefficient | Coefficient | Orientation |
| No. | (kGs) | (kOe) | (kOe) | (kOe) | (MGOe) | (Hk/Hcj) | (° C.) | \|α\| | \|β\| | Direction |
| Example 1 | 13.25 | 12.99 | 25.66 | 25.15 | 43.03 | 0.98 | 472.7 | 0.054 | 0.536 | 307 |
| Example 2 | 12.89 | 12.64 | 26.38 | 25.85 | 40.72 | 0.98 | 522.5 | 0.047 | 0.523 | 383 |
| Example 3 | 11.86 | 11.63 | 29.31 | 28.43 | 34.48 | 0.97 | 466.8 | 0.055 | 0.487 | 382 |
| Example 4 | 11.50 | 11.27 | 33.25 | 32.92 | 32.41 | 0.99 | 487.6 | 0.052 | 0.463 | 323 |
| Example 5 | 11.78 | 11.55 | 31.56 | 30.30 | 34.01 | 0.96 | 504.0 | 0.049 | 0.471 | 306 |
| Example 6 | 11.62 | 11.39 | 28.32 | 28.04 | 33.09 | 0.99 | 530.9 | 0.046 | 0.496 | 331 |
| Example 7 | 13.05 | 12.79 | 27.53 | 26.15 | 41.74 | 0.95 | 472.5 | 0.054 | 0.505 | 301 |
| Example 8 | 13.50 | 13.24 | 25.12 | 24.87 | 44.67 | 0.99 | 490.6 | 0.052 | 0.542 | 302 |
| Example 9 | 11.92 | 11.69 | 28.88 | 28.30 | 34.83 | 0.98 | 488.0 | 0.052 | 0.514 | 311 |
| Example 10 | 12.63 | 12.38 | 27.01 | 26.74 | 39.10 | 0.99 | 499.7 | 0.051 | 0.527 | 308 |
| Example 11 | 11.82 | 11.59 | 29.56 | 29.26 | 34.24 | 0.99 | 497.0 | 0.051 | 0.489 | 319 |
| Example 12 | 11.55 | 11.32 | 28.95 | 28.37 | 32.70 | 0.98 | 514.5 | 0.048 | 0.501 | 342 |
| Example 13 | 11.61 | 11.38 | 28.74 | 28.45 | 33.04 | 0.99 | 514.1 | 0.048 | 0.512 | 316 |
| Comparative | 11.83 | 11.60 | 20.03 | 19.03 | 34.30 | 0.95 | 495.7 | 0.059 | 0.751 | 223 |
| Example 1 | | | | | | | | | | |
| Comparative | 11.87 | 11.64 | 25.68 | 23.88 | 34.53 | 0.93 | 408.0 | 0.064 | 0.715 | 214 |
| Example 2 | | | | | | | | | | |
| Comparative | 11.79 | 11.56 | 15.25 | 13.88 | 34.07 | 0.91 | 571.9 | 0.042 | 0.811 | 211 |
| Example 3 | | | | | | | | | | |
| Comparative | 11.91 | 11.68 | 20.58 | 18.93 | 34.77 | 0.92 | 488.1 | 0.052 | 0.762 | 255 |
| Example 4 | | | | | | | | | | |
| Comparative | 11.13 | 10.91 | 26.13 | 24.56 | 30.36 | 0.94 | 490.2 | 0.052 | 0.659 | 265 |
| Example 5 | | | | | | | | | | |
| Comparative | 13.81 | 13.54 | 17.17 | 14.59 | 46.74 | 0.85 | 491.8 | 0.052 | 0.804 | 202 |
| Example 6 | | | | | | | | | | |
| Comparative | 10.85 | 10.64 | 34.58 | 30.78 | 28.85 | 0.89 | 488.2 | 0.052 | 0.457 | 305 |
| Example 7 | | | | | | | | | | |

It can be seen from Table 4 that the permanent magnets according to the examples of the present invention has higher remanence, coercive force and squareness, and has a lower remanence temperature coefficient and coercive force temperature coefficient and a higher magnet Curie temperature, and has excellent heat resistance.

1. A neodymium-iron-boron rare earth permanent magnet, comprising following components of:
R: 28.5-33 wt %, wherein R is a rare earth element, R comprises a light rare earth element RL and a heavy rare earth element RH, RL comprises Pr, Pr≥14 wt %, and RH comprises one or more of Dy, Tb, Gd and Ho;
Co: 12-20 wt %;
Al: 0.5-1.5 wt %;
X: 0.3-1.5 wt %, wherein X is one or more of Cu, Ga, Bi, Sn, Nb, Zr and Ti;
B: 0.88-1.05 wt %; and
a balance of Fe,
wherein wt % represents a mass percentage of a corresponding component in the neodymium-iron-boron rare earth permanent magnet, and a sum of all components is 100 wt %;
wherein the neodymium-iron-boron rare earth permanent magnet has a microstructure comprising a main phase M, a grain boundary phase A and a grain boundary phase B; the main phase M is R₂(Fe, Co)₁₄B having a volume percentage of 90-94%; the grain boundary phase A is R(Fe, Co)₂ having a volume percentage of 5-8%; and the grain boundary phase B is R₄(Fe, Co)₃ having a volume percentage of 1-2%.

2. The neodymium-iron-boron rare earth permanent magnet according to claim 1, wherein:
the Pr has a content of 14 wt %-24 wt % and/or
the RL further comprises Nd having a content of 1 wt %-14 wt % and/or
the RH has a content of 2 wt %-9 wt % and/or
the RH comprises Dy having a content of 0.2 wt %-5 wt % and/or
the RH comprises Tb having a content of 1 wt %-5 wt % and/or
the RH comprises Gd having a content of 0.5 wt %-1 wt %; and/or
the RH comprises Ho having a content of 0.5 wt %-2 wt % and/or
the Co has a content of 13 wt %, 19 wt %, 12 wt %, 15 wt %, 17 wt %, 20 wt %, 16 wt % or 18 wt %; and/or
the Al has a content of 0.8 wt %, 0.7 wt %, 0.6 wt %, 0.5 wt %, 1.5 wt %, 0.55 wt %, 1.1 wt % or 1.3 wt %; and/or
the X comprises Cu having a content of 0.15 wt %-0.3 wt % and/or
the X comprises Ga having a content of 0.3 wt %-0.6 wt % and/or
the X comprises Bi having a content of 0.1 wt %-0.2 wt %; and/or
the X comprises Sn having a content of 0.1 wt %-0.3 wt %; and/or
the X comprises Nb having a content of 0.1 wt %-0.3 wt %; and/or
the X comprises Zr having a content of 0.1 wt %-0.2 wt %; and/or
the X comprises Ti having a content of 0.1 wt % to 0.3 wt %.

3. The neodymium-iron-boron rare earth permanent magnet according to claim 1, wherein:
the main phase M comprises following components of:
26.6-30.55 wt % of R, wherein Pr: >12.5 wt %, Nd: 0-12.5 wt %, RH: 1.85-9.0 wt %;
Co: 11.8-20 wt %;
B: 0.88-1.01 wt %;
Fe: 48.5-58.5 wt %;
wherein wt % represents a mass percentage of a corresponding component in the main phase M, and a sum of all components is 100 wt %;
the main phase M further comprises one or more of Al, Cu, Zr, Ga and O;
and/or
the grain boundary phase A comprises following components of:
R: 52.8-62 wt %; wherein Pr: 24-50 wt %, Nd: 0-26.5 wt %, RH: 2.0-10 wt %;
Co: 15-25 wt %;
Fe: 12-25 wt %;
Al: 0.19-0.55 wt %
X: 0.1-0.6 wt %;
O: 0-0.5 wt %;
wherein wt % represents a mass percentage of a corresponding component in the grain boundary phase A, and a sum of all components is 100 wt %;
and/or
the grain boundary phase B comprises following components of:
R: 75-90.3 wt %; wherein Pr: 42.5-90 wt %, Nd: 0-42.5 wt %, RH: 0.3-1.5 wt %;
Co: 6-10 wt %;
Fe: 2-10 wt %;
Al: 0-0.2 wt %
X: 1.0-10 wt %;
O: 0.5-1.5 wt %;
wherein wt % represents a mass percentage of a corresponding component in the grain boundary phase B.

4. The neodymium-iron-boron rare earth permanent magnet according to claim 1, wherein:
a Co content c (A) in the grain boundary phase A is higher than a Co content c (M) in the main phase M, and c(A)-c(M)>3 wt %; and/or
a RH content in the grain boundary phase A is higher than that in the main phase M and higher than that in the grain boundary phase B; and/or
a RH content in the grain boundary phase B is lower than that in the main phase M and lower than that in the grain boundary phase A; and/or
a X content in the grain boundary phase B is higher than that in the main phase M, and higher than that in the grain boundary phase A.

5. The neodymium-iron-boron rare earth permanent magnet according to claim 1, wherein:
the neodymium-iron-boron rare earth permanent magnet further comprises an impurity phase, wherein the impurity phase has a content of 0.05%-0.55%; and/or
the main phase has a volume percentage of 90.45%, 90.00%, 91.81%, 92.73%, 92.11%, 93.66%, 93.23%, 92.81%, 93.45%, 93.22%, 91.53% or 92.33%; and/or
the grain boundary phase A has a volume percentage of 5.00%, 8.00%, 7.81%, 6.45%, 6.23%, 6.80%, 5.12%, 5.89%, 6.32%, 5.84%, 5.79%, 7.05% or 6.43%; and/or
the grain boundary phase B has a volume percentage of 0.78%, 1.30%, 2.00%, 1.54%, 0.75%, 0.90%, 0.67%, 0.65%, 0.78%, 0.50%, 0.81%, 1.05% or 0.83%.

6. The neodymium-iron-boron rare earth permanent magnet according to claim 1, wherein:
the microstructure of the neodymium-iron-boron rare earth permanent magnet comprises 94.00% of the main phase M, 5.00% of the grain boundary phase A, 0.78% of the grain boundary phase B and 0.22% of an impurity phase; or
the microstructure of the neodymium-iron-boron rare earth permanent magnet comprises 90.45% of the main phase M, 8.00% of the grain boundary phase A, 1.30% of the grain boundary phase B and 0.25% of an impurity phase; or
the microstructure of the neodymium-iron-boron rare earth permanent magnet comprises 90.00% of the main phase M, 7.81% of the grain boundary phase A, 2.00% of the grain boundary phase B and 0.19% of an impurity phase; or
the microstructure of the neodymium-iron-boron rare earth permanent magnet comprises 91.81% of the main phase M, 6.45% of the grain boundary phase A, 1.54% of the grain boundary phase B and 0.2% of an impurity phase; or
the microstructure of the neodymium-iron-boron rare earth permanent magnet comprises 92.73% of the main phase M, 6.23% of the grain boundary phase A, 0.75% of the grain boundary phase B and 0.29% of an impurity phase; or
the microstructure of the neodymium-iron-boron rare earth permanent magnet comprises 92.11% of the main phase M, 6.80% of the grain boundary phase A, 0.90% of the grain boundary phase B and 0.19% of an impurity phase; or
the microstructure of the neodymium-iron-boron rare earth permanent magnet comprises 93.66% of the main phase M, 5.12% of the grain boundary phase A, 0.67% of the grain boundary phase B and 0.55% of an impurity phase; or
the microstructure of the neodymium-iron-boron rare earth permanent magnet comprises 93.23% of the main phase M, 5.89% of the grain boundary phase A, 0.65% of the grain boundary phase B and 0.23% of an impurity phase; or
the microstructure of the neodymium-iron-boron rare earth permanent magnet comprises 92.81% of the main phase M, 6.32% of the grain boundary phase A, 0.78% of the grain boundary phase B and 0.09% of an impurity phase; or
the microstructure of the neodymium-iron-boron rare earth permanent magnet comprises 93.45% of the main phase M, 5.84% of the grain boundary phase A, 0.50% of the grain boundary phase B and 0.21% of an impurity phase; or
the microstructure of the neodymium-iron-boron rare earth permanent magnet comprises 93.22% of the main phase M, 5.79% of the grain boundary phase A, 0.81% of the grain boundary phase B and 0.18% of an impurity phase; or
the microstructure of the neodymium-iron-boron rare earth permanent magnet comprises 91.53% of the main phase M, 7.05% of the grain boundary phase A, 1.05% of the grain boundary phase B and 0.37% of an impurity phase; or
the microstructure of the neodymium-iron-boron rare earth permanent magnet comprises 92.33% of the main phase M, 6.43% of the grain boundary phase A, 0.83% of the grain boundary phase B and 0.41% of an impurity phase.

7. The neodymium-iron-boron rare earth permanent magnet according to claim 1, wherein:
the neodymium-iron-boron rare earth permanent magnet has a remanence temperature coefficient |α| at 20-100° C. of less than 0.056%/° C., and a coercive force temperature coefficient |β| at 20-100° C. of less than 0.55%/° C.; and/or
the neodymium-iron-boron rare earth permanent magnet has a Curie temperature Tc of greater than 450° C.; and/or
the neodymium-iron-boron rare earth permanent magnet has a coercive force Hcj Hcj≥25 kOe.

8. A method for preparing the neodymium-iron-boron rare earth permanent magnet according to claim 1, comprising subjecting a raw material composition for the neodymium-iron-boron rare earth permanent magnet to the following steps in sequence: smelting, casting, hydrogen decrepitation, shaping, sintering and aging treatments.

9. The method for preparing the neodymium-iron-boron rare earth permanent magnet according to claim 8, wherein:
the smelting is carried out in a high-frequency vacuum induction smelting furnace, wherein the high-frequency vacuum induction smelting furnace has a vacuum degree of 5×10⁻² Pa; the smelting is carried out at a temperature of 1600° C. or less; and the smelting is carried out in a crucible made of alumina; and/or
the casting comprises cooling a molten liquid obtained by the smelting through a rotating roller in an Ar atmosphere, wherein the Ar atmosphere has a pressure of 5.5×10⁴ Pa; the cooling has a speed of 102° C./sec-104° C./sec; the cooling is achieved by passing a cooling water through the roller, and the cooling water has an inlet temperature of ≤25° C.; and/or
the hydrogen decrepitation comprises hydrogen absorption, dehydrogenation, and cooling treatments, wherein the hydrogen absorption is carried out under a condition of a hydrogen pressure of 0.05-0.25 MPa; and the dehydrogenation is carried out under a condition of increasing the temperature while vacuum pumping; and/or
the method further comprises pulverization after the hydrogen decrepitation; the pulverization is performed by an jet mill pulverization; the jet mill pulverization is performed in a nitrogen atmosphere with an oxidizing gas content of less than 100 ppm; a pulverization chamber for the jet mill pulverization has a pressure of 0.58 MPa; the jet mill pulverization is performed for a time of 3 hours; a powder obtained after the pulverization has a particle size of 3.5-4.5 μm; after the pulverization, a lubricant is added to the powder; an amount of the lubricant added is 0.10-0.15% of the weight of the mixed powder; and/or
the shaping is magnetic field orientation shaping; the magnetic field orientation shaping is performed at a pressure of orientation pressing shaping of greater than 80 MPa, an orientation magnetic field of greater than 1.2T for a holding time for 4-6 s; after the magnetic field orientation shaping, a cold isostatic pressing can be performed at a pressure of 150-160 MPa; and/or
the sintering comprises preheating, sintering and cooling under a vacuum condition, wherein: the vacuum condition is 5×10⁻³ Pa; the preheating is performed at a temperature of 300-600° C.; the preheating time is performed for a time of 1-2 h; the preheating is performed for 1 h at 300° C. and 600° C. respectively; the sintering is performed at a temperature of 1040-1090° C.; the sintering time is performed for a time of 4 h; before the cooling, an Ar gas may be introduced to make the gas pressure reach 0.05-0.1 MPa; and the sintering does not comprise a rapid cooling process; and/or
the aging treatment comprises a primary aging treatment and a secondary aging treatment, wherein: the primary aging treatment is performed at a temperature of 860-960° C.; in the primary aging treatment, a heating rate to 860-960° C. is 3-5° C./min; the primary aging treatment is performed for a time of 3 h; the secondary aging treatment is performed at a temperature of 430-600° C.; in the secondary aging treatment, a heating rate to 430-600° C. is 3-5° C./min; and the secondary aging treatment is performed for a time of 3 h.

10. Use of the neodymium-iron-boron rare earth permanent magnet according to claim 1 in electronic components.
